(19) United States
(12) Patent Application Publication
(10) Pub. No.: US 2012/0019500 A1
(43) Pub. Date: Jan. 26, 2012

(54) ORGANIC LIGHT EMITTING DISPLAY DEVICE

(76) Inventors: Young-In Hwang, Yongin-city (KR); Sang-Moo Choi, Yongin-city (KR)

(21) Appl. No.: 13/004,842

(22) Filed: Jan. 11, 2011

(30) Foreign Application Priority Data
Jul. 20, 2010 (KR) 10-2010-0069937

(51) Int. Cl. G09G 3/30; G06F 3/038

(52) U.S. Cl. 345/211; 345/204; 345/76

(57) ABSTRACT

An embodiment relates to an organic light emitting display device that has a simple structure and compensate threshold voltage of a driving transistor.

The organic light emitting display device that operates in an initializing period, a scan period, and an emission period divided from one frame, includes: first pixels positioned in odd-numbered vertical lines; second pixels positioned in even-numbered vertical lines; first scan lines and second scan lines formed horizontal lines and coupled with the second pixels; third scan lines and fourth scan lines formed in the horizontal lines and coupled with the first pixels; and a scan driver driving the first scan lines and the fourth scan lines, in which the number of transistors in the first pixels is different from the number of transistors in the second pixels.

### CROSS-REFERENCE TO RELATED APPLICATION

This application claims priority to and the benefit of Korean Patent Application No. 10-2010-0069937, filed on Jul. 20, 2010, in the Korean Intellectual Property Office, the entire content of which is incorporated herein by reference.

### BACKGROUND

1. Field

Aspects of embodiments according to the present invention relate to an organic light emitting display device.

2. Description of Related Art

Recently, a variety of flat panel displays that make it possible to reduce the faults, the weight and the volume of cathode ray tubes, have been developed. Typical flat panel displays are liquid crystal displays, field emission displays, plasma display panels, organic light emitting display devices, etc.

The organic light emitting display device displays an image using organic light emitting diodes that produce light by recombining electrodes and holes. The organic light emitting display device has the advantage that it has fast response speed and low power consumption.

FIG. 1 is a circuit diagram illustrating a pixel of an organic light emitting display device in the related art.

Referring to FIG. 1, a pixel 4 of an organic light emitting display device of the related art includes: an organic light emitting diode OLED; and a pixel circuit 2 connected with a data line Dm and a scan line Sn for controlling the organic light emitting diode OLED.

The anode electrode of the organic light emitting diode OLED is connected to the pixel circuit 2, and the cathode electrode is connected to the second power supply ELVSS. The organic light emitting diode produces light with luminance (e.g., predetermined luminance) in response to the current supplied from the pixel circuit 2.

The pixel circuit 2 controls the amount of current supplied to the organic light emitting diode OLED, in response to a data signal supplied to the data line Dm, when a scan signal is supplied to the scan line Sn. For this configuration, the pixel circuit 2 includes: a second transistor M2 connected between a first power supply ELVDD and the organic light emitting diode OLED; a first transistor M1 connected to the second transistor M2, the data line Dm, and the scan line Sn; and a storage capacitor Cst connected between a gate electrode and a first electrode of the second transistor M2.

A gate electrode of the first transistor M1 is connected to the scan line Sn, and a first electrode of the first transistor M1 is connected to the data line Dm. Further, a second electrode of the first transistor M1 is connected to one terminal of the storage capacitor Cst. In this configuration, the first electrode is any one of a source electrode and a drain electrode, and the second electrode is the other electrode different from the first electrode. For example, when the first electrode is the source electrode, the second electrode is the drain electrode. The first transistor M1 connected to the scan line Sn and the data line Dm is turned on and supplies a data signal, which is supplied through the data line Dm, to the storage capacitor Cst. In this operation, the storage capacitor Cst is charged at a voltage corresponding to the data signal.

The gate electrode of the second transistor M2 is connected to one terminal of the storage capacitor Cst, and the first electrode of the second transistor M2 is connected to the first power supply ELVDD and the other terminal of the storage capacitor Cst. Further, the second electrode of the second transistor M2 is connected to the anode electrode of the organic light emitting diode OLED. The second transistor M2 controls the amount of current flowing from the first power supply ELVDD to the second power supply ELVSS through the organic light emitting diode OLED, in response to the voltage value stored in the storage capacitor Cst. In FIG. 1, the organic light emitting diode OLED emits light corresponding to the amount of current supplied from the second transistor M2.

However, the pixel 4 of the organic light emitting display device of the related art cannot display an image with uniform luminance. To be more specific, the second transistors M2 (driving transistor) in the pixels 4 have different threshold voltages for each pixel 4 due to process variation. As the threshold voltages of the driving transistors are different, the pixels 4 generate light with different luminance due to the difference in the threshold voltages of the driving transistors, even if data signals corresponding to the same gradation are supplied to the pixels 4.

In order to overcome the problems, a structure including an additional transistor is formed in each pixel 4 to compensate for the threshold voltage of the driving transistor. A structure compensating for the threshold voltage of a driving transistor, using six transistors and one capacitor for each pixel is known. However, the six transistors in the pixel complicate its structure. In particular, the possibility of malfunction is increased and yield is correspondingly decreased by the increased number of transistors in the pixels.

### SUMMARY

Aspects of embodiments according to the present invention are directed toward an organic light emitting display device having a simple structure and being capable of compensating for the threshold voltage of a driving transistor.

According to an embodiment of the present invention, there is provided an organic light emitting display device configured to be driven in an initializing period, a scan period, and an emission period of one frame. The organic light emitting display device includes: first pixels positioned in odd-numbered vertical lines; second pixels positioned in even-numbered vertical lines; first scan lines and second scan lines formed in horizontal lines and coupled with the second pixels; third scan lines and fourth scan lines formed in the horizontal lines and coupled with the first pixels; and a scan driver for driving the first scan lines and the fourth scan lines, in which the number of transistors in the first pixels is different from the number of transistors in the second pixels.

The organic light emitting display device may include: a data driver for supplying data signals to output lines of the data driver; first data lines formed in the odd-numbered vertical lines; second data lines formed in the even-numbered vertical lines; demultiplexers coupled with the output lines and for transmitting the data signals to the first data lines and the second data lines coupled thereto; a first power driver for applying first power having a low level and a high level to a first power line and a second power line coupled with the first pixels and the second pixels; connecting units positioned between the demultiplexers and the second data lines and each of the connecting units for connecting a corresponding one of the second data lines with a corresponding one of the demultiplexers or the first power line; and a second power driver for applying second power having a low level and a high level to the first pixels and the second pixels.

The second pixels may be coupled to the second data lines and the first pixels may be coupled to the first data lines and the second data lines which are adjacent to each other. Each of the pixels may include; an organic light emitting diode having a cathode electrode coupled to a second power supply for supplying the second power; a first transistor having a second electrode coupled to an anode electrode of the organic light emitting diode and a first electrode coupled to the second data line; a second transistor coupled between a gate electrode and the second electrode of the first transistor and being configured to be turned on when a first scan signal is supplied to the first scan line; a third transistor coupled between the first electrode of the first transistor and the second data line and being configured to be turned on when a second scan signal is supplied to the second scan line; and a storage capacitor coupled between the gate electrode of the first transistor and the second power line.

Each of the first pixel may include; an organic light emitting diode having a cathode electrode coupled to a second power supply for supplying the second power; a first transistor having a second electrode coupled to an anode electrode of the organic light emitting diode and a first electrode coupled to the second data line; a second transistor coupled between a gate electrode and the second electrode of the first transistor and being configured to be turned on when a third scan signal is supplied to the third scan line; a third transistor coupled between the first electrode of the first transistor and the second data line and being configured to be turned on when the second control signal is supplied; a fourth transistor coupled between the first electrode of the first transistor and the first data line and being configured to be turned on when a fourth scan signal is supplied to the fourth scan line; and a storage capacitor coupled between the gate electrode of the first transistor and the second power line.

According to an organic light emitting display device of the present invention and the pixels included in the organic light emitting display device, it is possible to compensate for the threshold voltage of a driving transistor while minimizing or reducing the number of transistors included in pixels.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a circuit diagram illustrating a pixel of the related art;

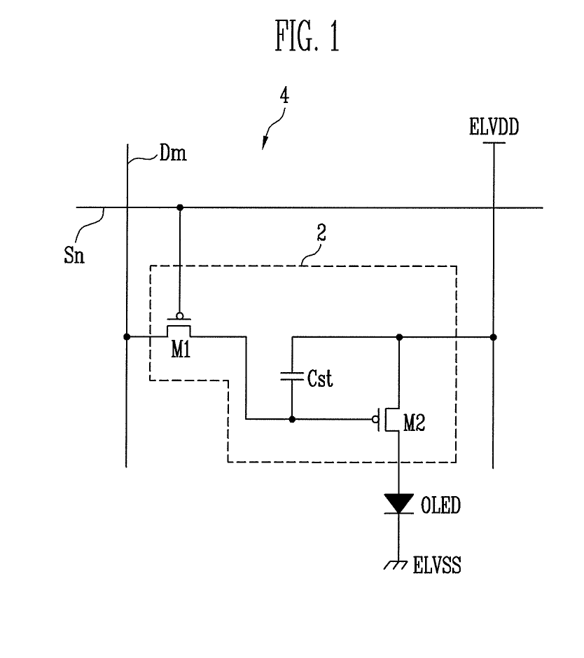

FIG. 2 is a block diagram illustrating an organic light emitting display device according to an embodiment of the present invention;

FIG. 3 is a circuit diagram illustrating an embodiment of the connecting unit and pixel shown in FIG. 2;

FIG. 4 is a waveform diagram illustrating a method of driving the connecting unit and pixel shown in FIG. 3; and

FIG. 5 is a circuit diagram illustrating another embodiment of the connecting unit and pixel shown in FIG. 2.

### DETAILED DESCRIPTION

Hereinafter, certain exemplary embodiments according to the present invention will be described with reference to the accompanying drawings. Here, when a first element is described as being coupled or connected to a second element, the first element may be directly coupled to the second element or may be indirectly coupled to the second element via a third element. Further, some of the elements that are not essential to a complete understanding of the invention are omitted for clarity. Also, like reference numerals refer to like elements throughout.

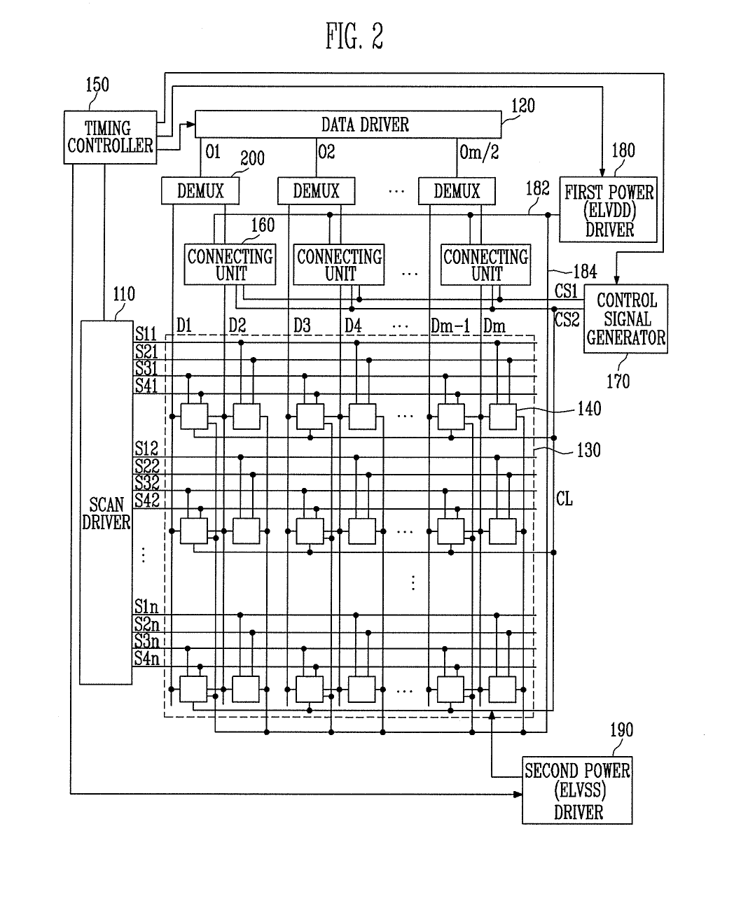

Exemplary embodiments for those skilled in the art to implement aspects of the present invention are described hereafter in detail with reference to FIGS. 2 to 5.

FIG. 2 is a block diagram illustrating an organic light emitting display device according to an embodiment of the present invention. Although FIG. 2 illustrates that two data lines are connected to a demultiplexer (hereafter, referred to as “DEMUX”) 200, the present invention is not limited thereto.

Referring to FIG. 2, an organic light emitting display device according to an embodiment of the present invention includes: first scan lines S11 to S1n, second scan lines S21 to S2n, third scan lines S31 to S3n, and fourth scan lines S41 to S4n, which are formed in each horizontal line; a scan driver 110 for driving the first scan line to the fourth scan lines S11 to S4n; a data driver 120 for sequentially supplying a plurality of data signals to output lines; DEMUXs 200 connected to the output lines; data lines D1 to Dm of which two adjacent ones are connected to each of the DEMUXs 200; and a display unit 130 including pixels positioned at the crossing regions of the data lines D1 to Dm and the first scan lines S11 to S1n.

Further, the organic light emitting display device according to an embodiment of the present invention includes: connection units 160 connected to even-numbered data lines D2, D4, . . . Dm; a first power driver 180 for supplying first power ELVDD to a first power line 182 and a second power line 184; a second power driver 190 for supplying second power ELVSS to pixels 140; a control signal generator 170 for supplying first and second control signals CS1 and CS2 to the connecting units 160; and a timing controller 150 for controlling the scan driver 110, the data driver 120, the control signal generator 170, the first power driver 180, and the second power driver 190.

The first scan lines S11 to S1n and the second scan lines S21 to S2n are formed in each horizontal line and electrically connected with the pixels 140 in the even-numbered vertical lines.

The third scan lines S31 to S3n and the fourth scan lines S41 to S4n are formed in each horizontal line and electrically connected with the pixels 140 in the odd-numbered vertical lines.

The scan driver 110 supplies first scan signals to the first scan signal lines S11 to S1n and second scan signals to the second scan lines S21 to S2n. Further, the scan driver 110 supplies third signals to the third scan lines S31 to S3n and fourth scan signals to the fourth scan lines S41 to S4n.

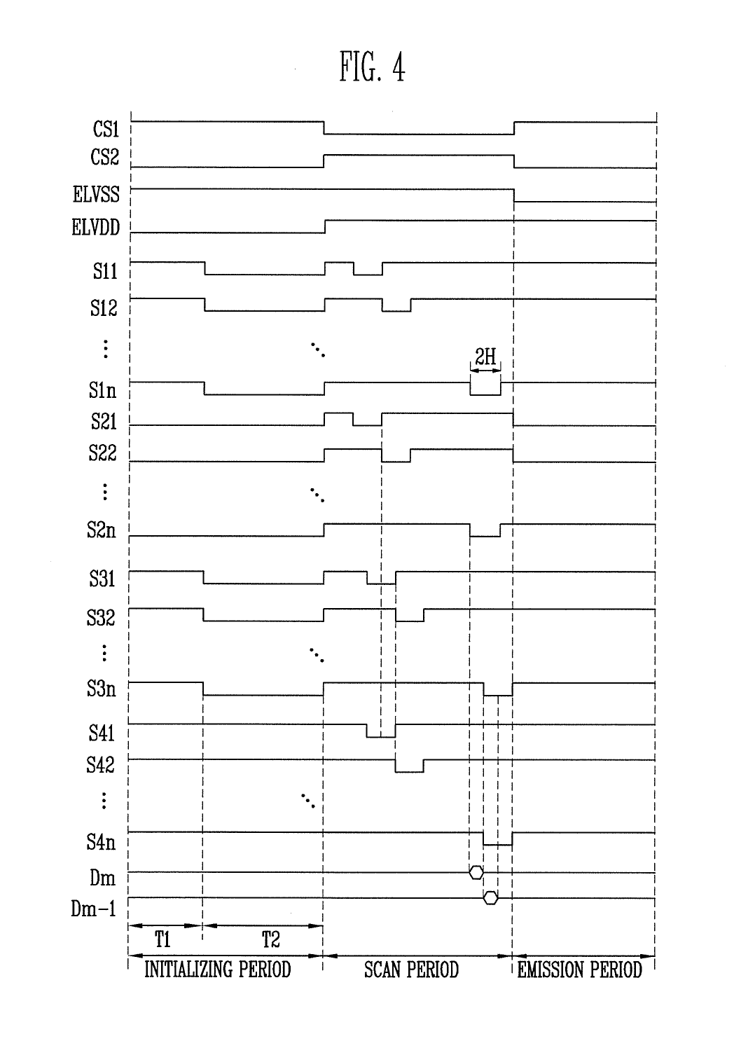

In detail, the scan driver 110, as shown in FIG. 4, supplies second scan signals to the second scan lines S21 to S2n for an initializing period and supplies first scan signals to the first scan lines S11 to S1n for a second period T2 in the initializing period. Further, the scan driver 110 sequentially supplies first scan signals to the first scan lines S11 to S1n and sequentially supplies second scan signals to the second scan lines S21 to S2n to be synchronized with the first scan signals for a scan period.

Further, the scan driver 110 concurrently (e.g., simultaneously) supplies third scan signals to the third scan lines S31 to S3n for the second period T2 in the initializing period. Further, the scan driver 110 sequentially supplies the third scan signals to the third scan lines S31 to S3n in or for the scan period to overlap the first scan signals for a predetermined period, and sequentially supplies fourth scan signals to the fourth scan lines S41 to S4n to be synchronized with the third scan signals.

In this configuration, the third scan signal supplied to the 3n-th scan line S3n overlaps the first scan signal supplied to the 1n-th scan line S1n for a predetermined period in the latter half. For example, when the first scan signal is supplied for two horizontal periods 2H, the third scan signal is supplied to overlap the first scan signal for the latter half period 1H of the two horizontal periods 2H.

The data driver 120 supplies a plurality of data signals to the output lines O1 to Om/2 in the scan period.

The DEMUXs 200 are connected to the output lines O1 to Om/2, respectively, and transmit two data signals respectively supplied to the output lines O1 to Om/2 to the odd-numbered data lines (or the first data line) and the even-numbered data lines (or the second data line) which are connected to the DEMUXs 200. For example, the DEMUXs 200 transmit data signals to the even-numbered data lines for a predetermined horizontal period 1H and transmit data signals to the odd-numbered data lines for a horizontal period 1H after the predetermined horizontal period 1H.

The first power driver 180 supplies the first power ELVDD to the first power line 182 and the second power line 184. In this configuration, the first power driver 180 supplies power, which repeats a high level and a low level, of the first power supply ELVDD during each of the fame period. For example, the first power driver 180 supplies low-level power of the first power supply ELVDD for the initializing period, and supplies high-level power of the first power supply ELVDD for the scan period and the emission period. The high-level first power ELVDD is set to a suitable voltage where current can flow in the pixel 140 (e.g., a voltage higher than a data signal) and the low-level first power ELVDD is set to a suitable voltage where current cannot flow in the pixel 140 (e.g., a voltage lower than the data signal).

The first power line 182 electrically connects the connecting units 160 with the first power driver 180. The second power line 184 electrically connects all of the pixels 140 with the first power driver 180. That is, the second power line 184 supplies the voltage of the first power supply ELVDD to the pixels 140, not through the connecting units 160.

The second power driver 190 supplies power of the second power supply ELVSS to the pixels 140. In this configuration, the second power driver 190 supplies power, which repeats a high level and a low level, of the second power supply ELVSS during each of the fame period. For example, the second power driver 190 supplies high-level power of the second power supply ELVSS for the initializing period and the scan period and supplies low-level power of the second power supply ELVSS for the emission period. The high-level second power ELVSS is set to a suitable voltage where current cannot flow in the pixel 140 (e.g., a voltage higher than a data signal) and the low-level second power ELVSS is set to a suitable voltage where current can flow in the pixel 140 (e.g., a voltage lower than the data signal).

The control signal generator 170 generates and supplies a first control signal CS1 and a second control signal CS2 to the connecting units 160. The first control signal CS1 and the second control signal CS2 are alternately supplied. For example, the control signal generator 170 supplies the second control signal CS2 for the initializing period and the emission period, and the first control signal CS1 for the scan period.

Additionally, the control signal generator 170 is electrically connected with the pixels 140 in the odd-numbered vertical lines through a control line CL. The control line CL is supplied with the second control signal CS2 from the control signal generator 170 and supplies the second control signal CS2 to the pixels 140 in the odd-numbered vertical line. Here, the second control signal CS2 generated from the control signal generator 170 is supplied to the pixels 140 in the odd-numbered vertical lines through the control line CL.

The connecting units 160 are connected to the even-numbered data lines D2, D4, . . . Dm, respectively. The connecting units 160 connect the even-numbered data lines D2, D4, . . . Dm to the DEMUXs 200 or the first power line 182, in response to the first control signal CS1 and the second control signal CS2.

The display unit 130 includes the pixels 140 at the crossing regions of the horizontal lines and the vertical lines. The pixels 140 (or first pixels) in the odd-numbered vertical lines are connected to the third scan line (any one of S31 to S3n), the fourth scan line (any one of S41 to S4n), the odd-numbered data line (any one of D1, D3 . . . Dm-1), the even-numbered data line (any one of D2, D4 . . . Dm), and the control line CL. The pixels 140 (or second pixels) in the even-numbered vertical lines are connected to the first scan lines S11 to S1n, the second scan lines S21 to S2n, and the even-numbered data lines (any one of D2, D4 . . . Dm)

In detail, the pixels 140 in the i-th vertical line (i is 1, 3, 5, . . . ) is connected to the i-th data line Di and the i+1-th data line Di+1, and the pixels 140 in the i+1-th vertical line is connected to the i+1-th data line Di+1. In this case, the number of transistors included in the pixels 140 in the odd-numbered vertical lines is different from the number of transistors in the pixels 140 in the even-numbered vertical lines. This will be described in detail below.

The pixels 140 are supplied with power from the first power supply ELVDD and the second power supply ELVSS. The pixels 140 controls the amount of current supplied to the second power supply ELVSS through the organic light emitting diodes from the first power supply ELVDD, in response to the data signals, during the emission period in one frame period. Accordingly, light having predetermined luminance is generated in the organic light emitting diodes.

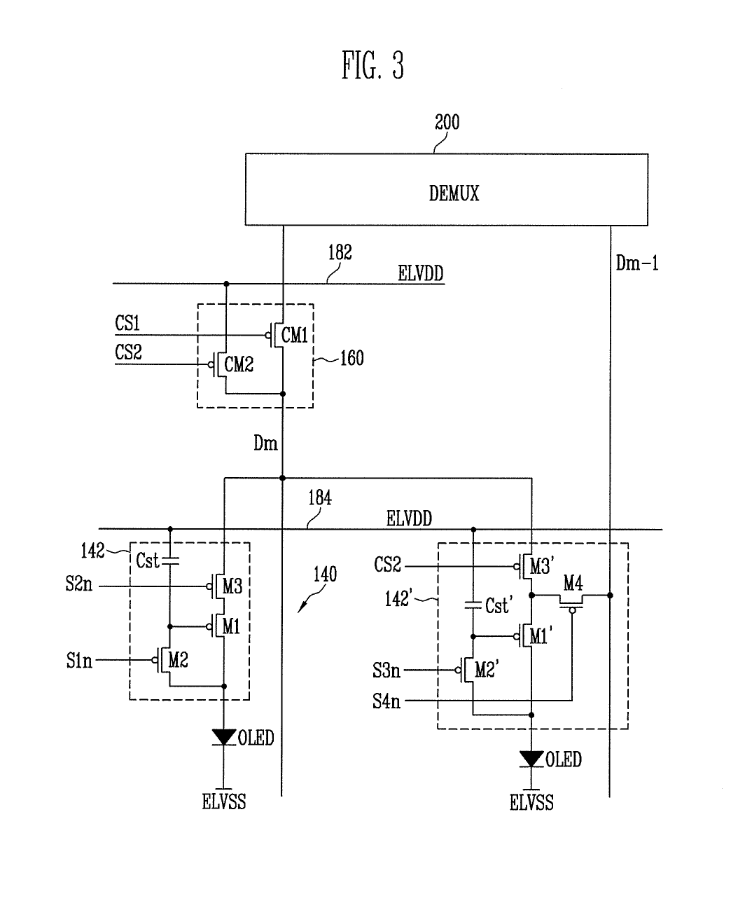

FIG. 3 is a circuit diagram illustrating a connecting unit and a pixel according to an embodiment of the present invention. FIG. 3 shows a configuration connected to the m-1-th data line Dm-1, the m-th data line Dm, the 1n-th scan line S1n, and the 3n-th scan line S3n, for the convenience of description.

Referring to FIG. 3, the connecting unit 160 according to an embodiment of the present invention includes a first control transistor CM1 and a second control transistor CM2.

The first control transistor CM1 is formed between the DEMUX 200 and the data line Dm. The first control transistor CM1 is turned on when the first control signal is supplied.

The second control transistor CM2 is connected between the first power line 182 and the data line Dm. The second control transistor CM2 is turned on when the second control signal is supplied. Practically, the first control transistor CM1 and the second control transistor CM2 connect the data line Dm to the first power line 182 or the DEMUX 200 while being alternately turned on.

The pixel 140 in the even-numbered vertical lines has an organic light emitting diode OLED and a pixel circuit 142 for controlling the amount of current supplied to the organic light emitting diode OLED.

The anode electrode of the organic light emitting diode OLED is connected to the pixel circuit 142, and the cathode electrode is connected to the second power supply ELVSS. The organic light emitting diode OLED produces light with luminance (e.g., predetermined luminance) in response to the current supplied from the pixel circuit 142.

The pixel circuit 142 is charged at a voltage corresponding to the data signal and the threshold voltage of the driving transistor, and controls the amount of current supplied to the organic light emitting diode OLED on the basis of the charged voltage. For this operation, the pixel circuit 142 includes first to third transistors M1 to M3 and a storage capacitor Cst.

A first electrode of the first transistor M1 is connected to a second electrode of the third transistor M3, and a second electrode of the first transistor M1 is connected to the anode electrode of the organic light emitting diode OLED. Further, a gate electrode of the first transistor M1 is connected to a first terminal of the storage capacitor Cst. The first transistor M1 controls the amount of current supplied to the organic light emitting diode OLED in response to the voltage charged at the storage capacitor Cst.

A first electrode of the second transistor M2 is connected to a second electrode of the first transistor M1, and a second electrode of the second transistor M2 is connected to a first terminal of the first capacitor C1. Further, a gate electrode of the second transistor M2 is connected to the first scan line S1n. The second transistor M2 is turned on and connects the first transistor M1 in a diode configuration, when a first scan signal is supplied to the first scan line S1n.

A first electrode of the third transistor M3 is connected to the data line Dm and the second electrode of the third transistor M3 is connected to the first electrode of the first transistor M1. Further, a gate electrode of the third transistor M3 is connected to the second scan line S2n. The third transistor M3 is turned on and electrically connects the first transistor M1 with the data line Dm when a second scan signal is supplied to the second scan line S2n.

The storage capacitor Cst is connected between the gate electrode of the first transistor M1 and the second power line 184. In this operation, the storage capacitor Cst is charged at a voltage corresponding to a data signal and a threshold voltage of the first transistor M1.

The pixel 140 in the odd-numbered vertical lines has an organic light emitting diode OLED and a pixel circuit 142′ for controlling the amount of current supplied to the organic light emitting diode OLED.

The anode electrode of the organic light emitting diode OLED is connected to the pixel circuit 142′, and the cathode electrode is connected to the second power supply ELVSS. The organic light emitting diode OLED produces light with luminance (e.g., predetermined luminance) in response to the current supplied from the pixel circuit 142′.

The pixel circuit 142′ is charged at a voltage corresponding to the data signal and the threshold voltage of the driving transistor, and controls the amount of current supplied to the organic light emitting diode OLED on the basis of the charged voltage. For this operation, the pixel circuit 142′ includes first to fourth transistors M1′ to M4 and a storage capacitor Cst′.

A first electrode of the first transistor M1′ is connected to a second electrode of the third transistor M3′, and a second electrode of the first transistor M1′ is connected to the anode electrode of the organic light emitting diode OLED. Further, a gate electrode of the first transistor M1′ is connected to a first terminal of the storage capacitor Cst′. The first transistor M1′ controls the amount of current supplied to the organic light emitting diode OLED in response to the voltage charged at the storage capacitor Cst′.

A first electrode of the second transistor M2′ is connected to the second electrode of the first transistor M1′, and a second electrode of the second transistor M2′ is connected to a first terminal of the first capacitor Cst′. Further, a gate electrode of the second transistor M2′ is connected to the third scan line S3n. The second transistor' M2 is turned on and connects the first transistor M1′ in a diode configuration when a third scan signal is supplied to the third scan line S3n.

A first electrode of the third transistor M3′ is connected to the data line Dm, and the second electrode of the third transistor M3′ is connected to the first electrode of the first transistor M1′. Further, the gate electrode of the third transistor M3′ is connected to the control line CL, which is connected to CS2. The third transistor M3′ is turned on and electrically connects the data line Dm with the first transistor M1′, when the second control signal CS2 is supplied to the control line CL.

A first electrode of the fourth transistor M4 is connected to the data line Dm-1, and a second electrode of the fourth transistor M4 is connected to the first electrode of the first transistor M1′. Further, a gate electrode of the fourth transistor M4 is connected to the fourth scan line S4n. The fourth transistor M4 is turned on and electrically connects the data line Dm-1 with the first electrode of the first transistor M1′ when a fourth scan signal is supplied to the fourth scan line S4n.

The storage capacitor Cst' is connected between the gate electrode of the first transistor M1′ and the second power line 184. In this operation, the storage capacitor Cst' is charged at a voltage corresponding to a data signal and a threshold voltage of the first transistor M1′.

FIG. 4 is a waveform diagram illustrating a driving method according to an embodiment of the connecting unit and pixel shown in FIG. 3.

Referring to FIG. 4, one frame period is divided into an initializing period, a scan period, and an emission period in an embodiment of the present invention.

The initializing period is divided into a first period T1 and a second period T2. The anode electrode of the organic light emitting diode OLED is initialized in the first period T1, and the gate electrodes of the first transistors M1 and M1′ are initialized in the second period T2.

The storage capacitors Cst and Cst′ in the pixels 140 are charged at a voltage corresponding to a data signal and threshold voltage of the first transistor M1/M1′ in the scan period. Since the second power supply ELVSS is set to a high level for the initializing period and the scan period, light is not emitted by the pixels 140.

The pixels 140 control the amount of current supplied to the organic light emitting diode OLED in response to the voltages charged at the storage capacitors Cst and Cst′, for the emission period.

Describing the operation in more detail, second scan signals are concurrently (e.g., simultaneously) supplied to the second scan lines S21 to S2n for the first period T1 in the initializing period, and the second control signal CS2 is supplied from the control signal generator 170. Further, the second power supply ELVSS is set at a high level and the first power supply ELVDD is set at a low level for the initializing period.

As the second scan signals are supplied to the second scan lines S21 to S2n, the third transistor M3 is turned on. Further, as the second control signal CS2 is supplied, the third transistor M3′ is turned on. In this case, the first electrodes of the first transistors M1 and M1′ in all of the pixels 140 are connected to the data line Dm. Here, when the second control transistor CM2 is turned on by the second control signal CS2, the low-level voltage of the first power supply ELVDD is supplied to the data line Dm. The voltage of the anode electrode of the organic light emitting diode OLED in each of the pixels 140 becomes higher than the data line Dm, such that the anode electrode of the organic light emitting diode OLED drops substantially to the voltage of the low-level first power supply ELVDD.

The first scan signals are supplied to the first scan lines S11 to S1n and the third scan signals are supplied to the third scan lines S31 to S3n for the second period T2 of the initializing period. As the first scan signals are supplied to the first scan lines S11 to S1n, the second transistors M2 in the pixels 140 in the even-numbered vertical lines are turned on. As the third scan signals are supplied to the third scan lines S31 to S3n, the second transistors M2′ in the pixels 140 in the odd-numbered vertical lines are turned on.

The anode electrode of the organic light emitting diode OLED and the gate electrode of the first transistors M1 and M1′ are electrically connected, when the second transistors M2 and M2′ in the pixels 140 are turned on. In this process, the gate electrode of the first transistors M1 and M1′ drops substantially to the voltage of the anode electrode of the organic light emitting diode OLED.

In more detail, the voltage applied to the anode electrode of the organic light emitting diode OLED for the first period T1 is stored in a parasitic capacitor of the organic light emitting diode OLED, which is not shown in the drawings. In this configuration, the parasitic capacitor of the organic light emitting diode OLED is set to have a capacity larger than the storage capacitor Cst/Cst′. Therefore, when the gate electrodes of the first transistors M1 and M1′ are respectively electrically connected with the anode electrodes of the organic light emitting diodes OLEDs for the second period T2, the voltages of the gate electrodes of the first transistors M1 and M1′ drop substantially to the voltages of the anode electrodes of the organic light emitting diodes OLEDs, respectively.

The first control transistor CM1 is turned on by the first control signal for the scan period. As the first control transistor CM1 is turned on, the data line Dm and the DEMUX 200 are electrically connected. Further, the first scan signals are sequentially supplied to the first scan lines S11 to S1n, and the second scan signals are sequentially supplied to the second scan lines S21 to S2n.

As the first scan signal is supplied to the 1n-th scan line S1n, the second transistor M2 is turned on, and as the second scan signal is supplied to the 2n-th scan line S2n, the third transistor M3 is turned on. In this process, the DEMUX 200 supplies a data signal to the m-th data line Dm. The data signal supplied to the data line Dm is supplied to the first terminal of the storage capacitor Cst through the first transistor M1 connected in a diode configuration. The storage capacitor Cst is charged at a voltage corresponding to the data signal and the threshold voltage of the first transistor M1.

On the other hand, the data signal supplied to the m-th data line Dm is supplied for a predetermined period while the first scan signal is supplied. For example, assuming that the first scan signal is supplied for a 2H period, the data signal supplied to the data line Dm is supplied for the first half 1H period. However, the storage capacitor Cst is continuously charged at the voltage corresponding to the data signal for the later half 1H period in which the first scan signal is supplied, even if supply of the data signal to the data line Dm is stopped.

In more detail, the data signal supplied to the m-th data line Dm is supplied to the pixel 140, after being applied to a parasitic capacitor of the m-th data line Dm. Therefore, even if supply of the data signal to the m-th data line Dm is stopped, the storage capacitor Cst can be charged at the voltage corresponding to the threshold voltage of the first transistor M1 and the data signal while the third transistor M3 and the second transistor M2 are kept turned on.

The third scan signals are sequentially supplied to the third scan lines S31 to S3n and the fourth scan signals are sequentially supplied to the fourth scan lines S41 to S4n, in or for the scan period.

The third scan signal supplied to the 3n-th scan line and the fourth scan signal supplied to the 4n-th scan line S4n are supplied to partially overlap the first scan signal supplied to the 1n-th scan line S1n. For example, when the first control signal is supplied to the 1n-th scan line S1n for a 2H period, the third scan signal and the fourth scan signal are supplied to the 3n-th scan line S3n and the 4n-th scan line S4n to overlap the first scan signal for the later half 1H period.

As the third scan signal is supplied to the 3n-th scan line S3n, the second transistor M2′ is turned on, and as the fourth scan signal is supplied to the 4n-th scan line S4n, the fourth transistor M4 is turned on. In this process, the DEMUX 200 supplies a data signal to the m-1-th data line Dm-1. The data signal supplied to the m-1-th data line Dm-1 is supplied to the first terminal of the storage capacitor Cst′ through the first transistor M1′ connected in a diode configuration. The storage capacitor Cst′ is charged at a voltage corresponding to the data signal and the threshold voltage of the first transistor M1′.

On the other hand, the data signal supplied to the m-1-th data line Dm-1 is supplied for a predetermined period while the third scan signal is supplied. For example, assuming that the third scan signal is supplied for a 2H period, the data signal supplied to the data line Dm-1 is supplied for the first half 1H period. However, the storage capacitor Cst′ is continuously charged at the voltage corresponding to the data signal for the later half 1H period by the parasitic capacitor of the data line Dm-1 while the third scan signal is supplied, even if supply of the data signal to the data line Dm-1 is stopped.

The second control transistor CM2 is turned on by the second control signal CS2 for the emission period, and accordingly, the voltage of the high-level first power supply ELVDD is supplied to the m-th data line Dm. Further, the third transistors M3 in the pixels 140 in the even-numbered vertical lines are turned on in response to the scan signals supplied to the second scan lines S21 to S2n and the third transistors M3′ in the pixels 140 in the odd-numbered vertical lines are turned on in response to the second control signal CS2, for the emission period.

In this case, the first transistors M1 and M1′ in the pixels 140 are electrically connected with the m-th data line Dm, and accordingly, the first transistors M1 and M1′ controls the amount of current flowing from the first power supply ELVDD to the second power supply ELVSS through the organic light emitting diode OLEDs, in accordance with the voltage charged at the storage capacitors Cst and Cst′.

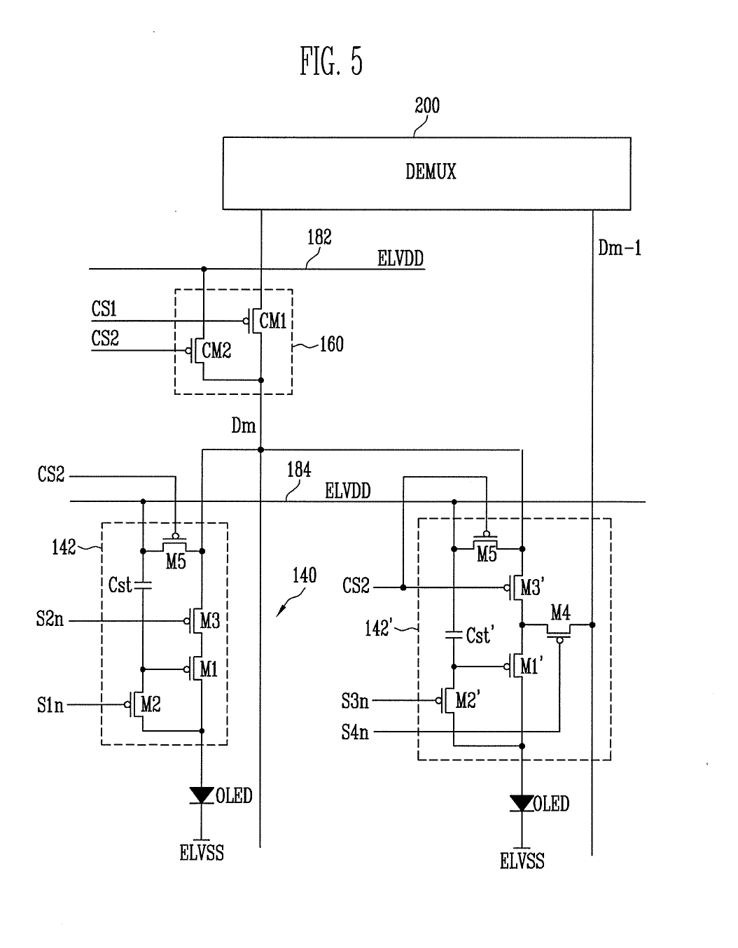

FIG. 5 is a circuit diagram illustrating a connecting unit and a pixel according to another embodiment of the present invention. In explaining FIG. 5, the same components as in FIG. 3 are designated by the same reference numerals and the detailed description is not provided.

Referring to FIG. 5, a pixel 140 according to another embodiment of the present invention further includes a fifth transistor M5 connected between the data line Dm and the second power line 184.

The fifth transistor M5 is turned on and electrically connects the second terminal of the storage capacitor Cst or Cst′ with the first terminal of the third transistor M3 or M3′, when the second control signal CS2 is supplied. Practically, the fifth transistor M5 is turned on for the initializing period and the emission period and electrically connects the first control line 182 with the second control line 184 such that voltage drop of the first power supply ELVDD is minimized. The others of the driving method are the same as those shown in FIG. 3, and their detailed description is not provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device configured to be driven in an initializing period, a scan period, and an emission period of one frame, the organic light emitting display device comprising:
first pixels positioned in odd-numbered vertical lines;
second pixels positioned in even-numbered vertical lines;
first scan lines and second scan lines formed in horizontal lines and coupled with the second pixels;
third scan lines and fourth scan lines formed in the horizontal lines and coupled with the first pixels; and
a scan driver for driving the first scan lines to the fourth scan lines,
wherein the number of transistors in the first pixels is different from the number of transistors in the second pixels.

2. The organic light emitting display device as claimed in claim 1, further comprising:
a data driver for supplying data signals to output lines of the data driver;
first data lines formed in the odd-numbered vertical lines;
second data lines formed in the even-numbered vertical lines;
demultiplexers coupled with the output lines and for transmitting the data signals to the first data lines and the second data lines coupled thereto;
a first power driver for applying first power having a low level and a high level to a first power line and a second power line coupled with the first pixels and the second pixels;
connecting units positioned between the demultiplexers and the second data lines, each of the connecting units for selectively connecting a corresponding one of the second data lines with a corresponding one of the demultiplexers or the first power line; and
a second power driver for applying second power having a low level and a high level to the first pixels and the second pixels.

3. The organic light emitting display device as claimed in claim 2, wherein the first power driver is configured to supply the first power at the low level for the initializing period and to supply the first power at the high level for the scan period and emission period.

4. The organic light emitting display device as claimed in claim 2, wherein the second power driver is configured to supply the second power at the high level for the initializing period and the scan period, and to supply the second power at the low level for the emission period.

5. The organic light emitting display device as claimed in claim 2, wherein the second pixels are coupled to the second data lines and the first pixels are coupled to the first data lines and the second data lines which are adjacent to each other.

6. The organic light emitting display device as claimed in claim 2, wherein each of the pixels comprises:
an organic light emitting diode having a cathode electrode coupled to a second power supply for supplying the second power;
a first transistor having a second electrode coupled to an anode electrode of the organic light emitting diode and a first electrode coupled to the second data line;
a second transistor coupled between a gate electrode and the second electrode of the first transistor and being configured to be turned on when a first scan signal is supplied to the first scan line;
a third transistor coupled between the first electrode of the first transistor and the second data line and being configured to be turned on when a second scan signal is supplied to the second scan line; and
a storage capacitor coupled between the gate electrode of the first transistor and the second power line.

7. The organic light emitting display device as claimed in claim 6, wherein the scan driver is configured to concurrently supply the second scan signals to the second scan lines in the initializing period and the emission period, and to sequentially supply the second scan signals to the second scan lines in the scan period.

8. The organic light emitting display device as claimed in claim 7, wherein the scan driver is configured to concurrently supply first scan signals to the first scan lines for a first period in the initializing period, and to sequentially supply the first scan signals to the first scan lines to be synchronized with the second scan signals in the scan period.

9. The organic light emitting display device as claimed in claim 7, wherein the second scan signals supplied in the scan period are supplied for two horizontal periods, and data signals are supplied to the second data lines through the demultiplexers for a first half period of the two horizontal periods.

10. The organic light emitting display device as claimed in claim 6, wherein each of the pixels further comprises a fifth transistor coupled between the second power line and the second data lines and turned on for the initializing period and the emission period.

11. The organic light emitting display device as claimed in claim 2, further comprising a control signal generator for supplying a first control signal corresponding to a connection between the second data line and the demultiplexer and a second control signal corresponding to a connection between the second data line and the first power line to the connecting unit.

12. The organic light emitting display device as claimed in claim 11, wherein each of the first pixels comprises:
an organic light emitting diode having a cathode electrode coupled to a second power supply for supplying the second power;
a first transistor having a second electrode coupled to an anode electrode of the organic light emitting diode and a first electrode coupled to the second data line;
a second transistor coupled between a gate electrode and the second electrode of the first transistor and being configured to be turned on when a third scan signal is supplied to the third scan line;
a third transistor coupled between the first electrode of the first transistor and the second data line and being configured to be turned on when the second control signal is supplied;
a fourth transistor coupled between the first electrode of the first transistor and the first data line and being configured to be turned on when a fourth scan signal is supplied to the fourth scan line; and
a storage capacitor coupled between the gate electrode of the first transistor and the second power line.

13. The organic light emitting display device as claimed in claim 12, wherein the scan driver is configured to concurrently supply third scan signals to the third scan lines for a first period of the initializing period.

14. The organic light emitting display device as claimed in claim 12, wherein the scan driver is configured to sequentially supply third scan signals to the third scan lines and to sequentially supply the fourth scan signals to the fourth scan lines to be synchronized with the third scan signals in the scan period.

15. The organic light emitting display device as claimed in claim 14, wherein the scan driver is configured to supply the third scan signals in the scan period for two horizontal periods, and data signals are supplied to the first data lines through the demultiplexers for a first half period of the two horizontal periods.

16. The organic light emitting display device as claimed in claim 12, wherein each of the first pixels further comprises a fifth transistor coupled between the second power line and the second data lines and is configured to be turned on concurrently with the third transistor.

17. The organic light emitting display device as claimed in claim 11, wherein the control signal generator is configured to supply the first control signal in the scan period and to supply the second control signal in the initializing period and the emission period.

18. The organic light emitting display device as claimed in claim 11, wherein the connection unit comprises:
a first control transistor coupled between the demultiplexer and the second data line and is configured to be turned on when the first control signal is supplied; and
a second control transistor coupled between the first power line and the second data line and is configured to be turned on when the second control signal is supplied.
